(19) United States
(12) Patent Application Publication
(10) Pub. No.: US 2026/0111326 A1
(43) Pub. Date: Apr. 23, 2026

(54) SYSTEMS AND METHODS FOR REAL-TIME ASSESSMENT OF AIR MOVER COOLING EFFICIENCY USING KEY PERFORMANCE INDICATORS

(71) Applicant: Dell Products L.P., Round Rock, TX (US)

(72) Inventors: Koushik MONDAL, Bengaluru (IN); Ibrahim SAYYED, Georgetown, TX (US); Balasingh P. SAMUEL, Round Rock, TX (US); Suraj M. VARMA, Portland, OR (US); Travis NORTH, Cedar Park, TX (US)

(73) Assignee: Dell Products L.P., Round Rock, TX (US)

(21) Appl. No.: 18/924,607

(22) Filed: Oct. 23, 2024

(51) Int. Cl. G06F 11/30; G06F 1/20; G06F 11/34

(52) U.S. Cl. CPC G06F 11/3058; G06F 1/20; G06F 11/3024; G06F 11/3409

(57) ABSTRACT

An information handling system may include a processor, an air mover configured to drive airflow within the information handling system, and a management controller communicatively coupled to the processor. The management controller may be configured to assess a cooling efficiency of the air mover by causing a constant computational load to be executed by the processor, during execution of the computational load, collecting data regarding power consumption by the processor, an ambient temperature of the information handling system, a package temperature of the processor, and a speed of the air mover, analyzing a distribution of the package temperature relative to the speed of the air mover, and determining the air mover to be degraded in performance if the distribution is statistically right-skewed.

### TECHNICAL FIELD

The present disclosure relates in general to information handling systems, and more particularly to assessing the cooling efficiency of one or more air movers of information handling system components using key performance indicators.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As processors, graphics cards, random access memory (RAM) and other components in information handling systems have increased in clock speed and power consumption, the amount of heat produced by such components as a side-effect of normal operation has also increased. Often, the temperatures of these components need to be kept within a reasonable range to prevent overheating, instability, malfunction and damage leading to a shortened component lifespan. Accordingly, air movers (e.g., cooling fans and blowers) have often been used in information handling systems to cool information handling systems and their components.

In information handling systems, it may be critical to determine when air mover performance has degraded, and air mover cooling efficiency has decreased. Traditionally, system air mover diagnostics are periodically executed by information technology dependent manual (ITDM) processes or on-demand by a user. Such approach has disadvantages in that it does not enable detection of a degradation of expected performance at elevated levels of system heat and load and the end-of-life period of air movers. Consequently, a user may have a bad user experience due to increased system throttling or increased acoustic levels due to such degradation.

Accordingly, methods and systems to proactively identify air mover degradation may be desired.

### SUMMARY

In accordance with the teachings of the present disclosure, the disadvantages and problems associated with traditional approaches to evaluating air mover efficiency may be substantially reduced or eliminated.

In accordance with embodiments of the present disclosure, an information handling system may include a processor, an air mover configured to drive airflow within the information handling system, and a management controller communicatively coupled to the processor. The management controller may be configured to assess a cooling efficiency of the air mover by causing a constant computational load to be executed by the processor, during execution of the computational load, collecting data regarding power consumption by the processor, an ambient temperature of the information handling system, a package temperature of the processor, and a speed of the air mover, analyzing a distribution of the package temperature relative to the speed of the air mover, and determining the air mover to be degraded in performance if the distribution is statistically right-skewed.

In accordance with these and other embodiments of the present disclosure, a method for assessing a cooling efficiency of an air mover may include causing a constant computational load to be executed by a processor, during execution of the computational load, collecting data regarding power consumption by a processor, an ambient temperature of an information handling system comprising the processor and the air mover, a package temperature of the processor, and a speed of the air mover, analyzing a distribution of the package temperature relative to the speed of the air mover, and determining the air mover to be degraded in performance if the distribution is statistically right-skewed.

In accordance with these and other embodiments of the present disclosure, an article of manufacture may include a non-transitory computer-readable medium and computer-executable instructions carried on the computer-readable medium, the instructions executable on a processing device, the instructions, when read and executed, for causing the processing device to: cause a constant computational load to be executed by a processor; during execution of the computational load, collect data regarding power consumption by a processor, an ambient temperature of an information handling system comprising the processor and an air mover, a package temperature of the processor, and a speed of the air mover; analyze a distribution of the package temperature relative to the speed of the air mover; and determine the air mover to be degraded in performance if the distribution is statistically right-skewed.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a flow chart of an example method for real-time assessment of fan cooling efficiency, in accordance with embodiments of the present disclosure; and

FIG. 3 illustrates a flow chart of an example method for detecting air mover degradation in connection with the method of FIG. 2, in accordance with embodiments of the present disclosure.

### DETAILED DESCRIPTION

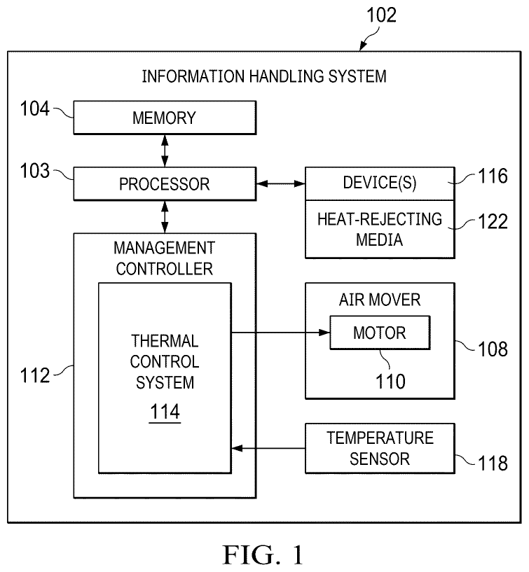

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, buses, memories, I/O devices and/or interfaces, storage resources, network interfaces, motherboards, integrated circuit packages; electro-mechanical devices (e.g., air movers), displays, and power supplies.

FIG. 1 illustrates a block diagram of selected components of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data. As shown in FIG. 1, information handling system 102 may comprise a processor 103, a memory 104 communicatively coupled to processor 103, an air mover 108, a management controller 112, one or more devices 116 communicatively coupled to processor 103, a temperature sensor 118, and heat-rejecting media 122 thermally coupled to device(s) 116.

Processor 103 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may comprise any system, device, or apparatus operable to retain program instructions or data for a period of time. Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off.

Air mover 108 may include any mechanical or electro-mechanical system, apparatus, or device operable to move air and/or other gases in order to cool information handling resources of information handling system 102. In some embodiments, air mover 108 may comprise a fan (e.g., a rotating arrangement of vanes or blades which act on the air). In other embodiments, air mover 108 may comprise a blower (e.g., a centrifugal fan that employs rotating impellers to accelerate air received at its intake and change the direction of the airflow). In these and other embodiments, rotating and other moving components of air mover 108 may be driven by a motor 110. The rotational speed of motor 110 may be controlled by an air mover control signal (e.g., a pulse-width modulation signal) communicated from thermal control system 114 of management controller 112. In operation, air mover 108 may cool information handling resources of information handling system 102 by drawing cool air into an enclosure housing the information handling resources from outside the chassis, expelling warm air from inside the enclosure to the outside of such enclosure, and/or moving air across one or more heat sinks (not explicitly shown) internal to the enclosure to cool one or more information handling resources.

Management controller 112 may comprise any system, device, or apparatus configured to facilitate management and/or control of information handling system 102 and/or one or more of its component information handling resources. Management controller 112 may be configured to issue commands and/or other signals to manage and/or control information handling system 102 and/or its information handling resources. Management controller 112 may comprise a microprocessor, microcontroller, DSP, ASIC, field programmable gate array (“FPGA”), EEPROM, or any combination thereof. Management controller 112 also may be configured to provide out-of-band management facilities for management of information handling system 102. Such management may be made by management controller 112 even if information handling system 102 is powered off or powered to a standby state. In certain embodiments, management controller 112 may include or may be an integral part of a baseboard management controller (BMC), a remote access controller (e.g., a Dell Remote Access Controller or Integrated Dell Remote Access Controller), or an enclosure controller. In other embodiments, management controller 112 may include or may be an integral part of a chassis management controller (CMC).

As shown in FIG. 1, management controller 112 may include a thermal control system 114. Thermal control system 114 may include any system, device, or apparatus configured to receive one or more signals indicative of one or more temperatures within information handling system 102 (e.g., one or more signals from one or more temperature sensors 118) and based on such one or more signals, calculate an air mover driving signal (e.g., a pulse-width modulation signal) to maintain an appropriate level of cooling, increase cooling, or decrease cooling, as appropriate, and communicate such air mover driving signal to air mover 108. Thermal control for air mover 108 by thermal control system 114 may be performed in any suitable manner, for example, as described in U.S. Pat. No. 10,146,190 entitled “Systems and Methods for Providing Controller Response Stability in a Closed-Loop System.”

In addition, thermal control system 114 may also be configured to maintain acoustic limits and/or maintain acoustic preferences for sound generated by air mover 108, for example, as described in U.S. patent application Ser. No. 16/852,118, filed Apr. 17, 2020, and entitled “Systems and Methods for Acoustic Limits of Thermal Control System in an Information Handling System,” which is incorporated by reference herein in its entirety.

Further, thermal control system 114 may also be configured to perform real-time assessment of cooling efficiency of air mover 108 using key performance indicators, as described in greater detail below.

In some embodiments, thermal control system 114 may include a program of instructions (e.g., software, firmware) configured to, when executed by a processor or controller integral to management controller 112, carry out the functionality of thermal control system 114.

A device 116 may comprise any component information handling system of information handling system 102, including without limitation processors, buses, memories, I/O devices and/or interfaces, storage resources, network interfaces, motherboards, integrated circuit packages; electro-mechanical devices, displays, and power supplies.

Temperature sensor 118 may comprise any system, device, or apparatus (e.g., a thermometer, thermistor, etc.) configured to communicate a signal to thermal control system 114 indicative of a temperature within information handling system 102.

Heat-rejecting media 122 may include any system, device, or apparatus configured to transfer heat from an information handling resource (e.g., device(s) 116, as shown in FIG. 1), thus reducing a temperature of the information handling resource. For example, heat-rejecting media 122 may include one or more solids thermally coupled to the information handling resource (e.g., heat pipe, heat spreader, heatsink, finstack, etc.) such that heat generated by the information handling resource is transferred from the information handling resource. Further, heat-rejecting media 122 may be arranged to be located within the airflow path of airflow generated by air mover 108, such that heat transferred to heat-rejecting media 122 from device 116 may further be transferred to such airflow. Although, for purposes of clarity and exposition, heat-rejecting media 122 is shown as being thermally coupled to device(s) 116, it is understood that heat-rejecting media 122 may also be thermally coupled to other information handling resources (e.g., processor 103 and/or memory 104) of information handling system 102 in addition to or in lieu of being thermally coupled to device 116.

In addition to processor 103, memory 104, air mover 108, management controller 112, device(s) 116, temperature sensor 118, and heat-rejecting media 122, information handling system 102 may include one or more other information handling resources. In addition, for the sake of clarity and exposition of the present disclosure, FIG. 1 depicts only one air mover 108 and temperature sensor 118. In embodiments of the present disclosure, information handling system 102 may include any number of air movers 108 and temperature sensors 118.

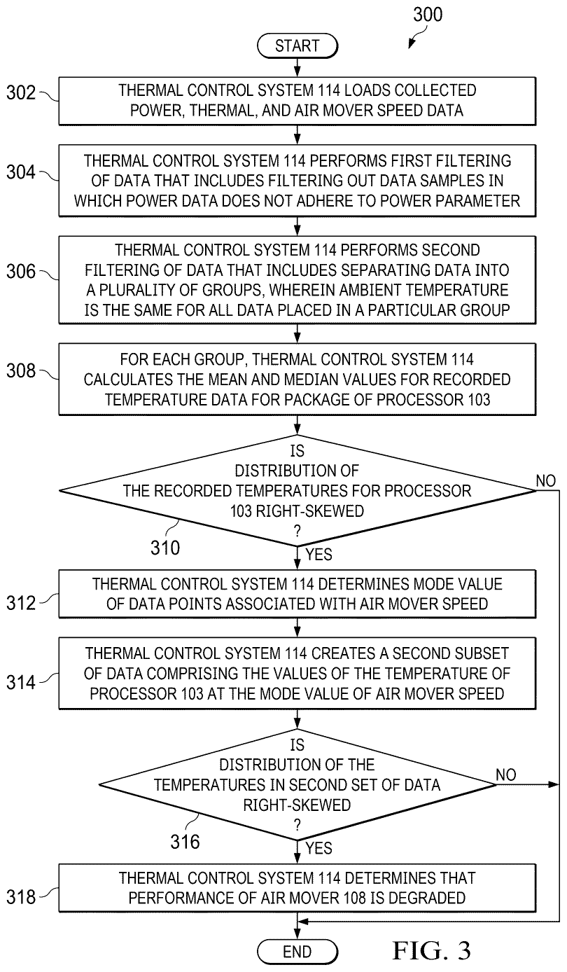

As mentioned above, thermal control system 114 may also be configured to perform real-time assessment of cooling efficiency of air mover 108 using key performance indicators. Such assessment may include two stages. In the first stage, thermal control system 114 may generate a constant load within information handling system 102 and gather data necessary for analysis and correlation. In the second stage, described in greater detail below with respect to method 300 of FIG. 3, thermal control system 114 may perform a statistical analysis of the collected data to identify whether a temperature data distribution with respect to air mover speed is right-skewed. Right-skew of the temperature data may statistically indicate that temperature is increasing over time and the performance of air mover 108 is degrading.

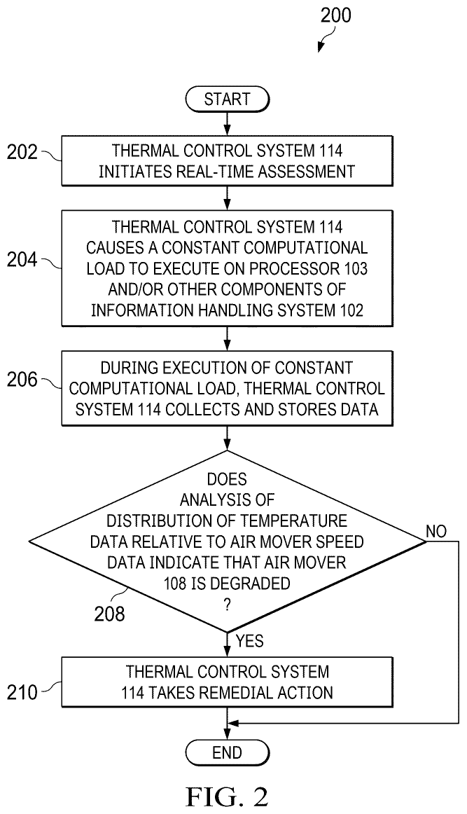

FIG. 2 illustrates a flow chart of an example method 200 for real-time assessment of fan cooling efficiency, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, thermal control system 114 may initiate the real-time assessment. In some embodiments, thermal control system 114 may initiate the real-time assessment, for example in response to a user request.

At step 204, thermal control system 114 may begin data sampling by causing a constant computational load to execute on processor 103 and/or other components of information handling system 102. For example, a constant computational load may execute such that processor 103 consumes a constant amount of power (e.g., 10W) for a predefined period of time.

At step 206, during execution of the constant computational load, thermal control system 114 may collect and store data, including without limitation power consumed by processor 103, speed of air mover 108 (e.g., rotational speed of motor 110), temperature data regarding the package of processor 103, an ambient temperature of information handling system 102, and/or any other suitable data. Such data sampling may include samples of varying sample length (e.g., 1 second, 3 seconds, 5 seconds, etc.).

At step 208, thermal control system 114 may analyze the collected data to determine if a distribution of the temperature data relative to the air mover speed data indicates that air mover 108 is degraded. Initially, collected data for each sampling interval may be engineered and smoothed, for example, by creating a first subset of the data for each time interval, the first subset of data generated by filtering the data twice. The first filtering may comprise filtering out data samples in which the load injection of step 204 does not adhere to a power parameter (e.g., those data points in which power consumed by processor 103 does not equal a certain amount, such as 10 W). The second filtering may comprise filtering the data into a plurality of groups, wherein the ambient temperature is the same (e.g., within a statistical tolerance) for all data placed in a particular group. Then for each group, thermal control system 114 may calculate the mean and median values for the recorded temperature data for the package of processor 103. From these mean and median values, thermal control system 114 may determine if the distribution of the recorded temperatures for processor 103 is right-skewed, meaning the mean exceeds the median for such data. If the data is right-skewed, then the temperature may be rising with respect to air mover speed.

If the temperature data for processor 103 is right-skewed, then thermal control system 114 may determine the mode value of the data points associated with air mover speed, that is, the most-frequent occurrence of the air mover speed. After determining the mode of the air mover speed, thermal control system 114 may create a second subset of data comprising the values of the temperature of processor 103 at such mode value of air mover speed.

In the second subset of data, thermal control system 114 may determine if the mean of temperature values in the second subset of data is greater than the median of the second subset of data (e.g., if the second subset of data is right-skewed). Right-skew of the second subset of data may be indicative of degradation of air mover 108. If the second subset of data is right-skewed, method 200 may proceed to step 210, otherwise, method 200 may end.

At step 210, thermal control system 114 may take a remedial action in response to the second subset of data being right-skewed. Such remedial action may include, without limitation, communication of an alert, proactive throttling of speed of processor 103, and/or any other suitable action. After completion of step 210, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using thermal control system 114 and/or any other system operable to implement method 200. In certain embodiments, method 200 may be implemented partially or fully in software and/or firmware embodied in computer-readable media.

FIG. 3 illustrates a flow chart of an example method 300 for detecting air mover degradation in connection with method 200, in accordance with embodiments of the present disclosure. In particular, in some embodiments, method 300 may be used to implement step 208 of method 200. According to some embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, thermal control system 114 may load collected power, thermal, and air mover speed data (e.g., recorded at step 206 of method 200). At step 304, thermal control system 114 may perform a first filtering of the data that includes filtering out data samples in which the load injection of step 204 does not adhere to a power parameter (e.g., those data points in which power consumed by processor 103 does not equal a certain amount, such as 10 W). At step 306, thermal control system 114 may perform a second filtering of the data that includes separating the data into a plurality of groups, wherein the ambient temperature is the same (e.g., within a statistical tolerance) for all data placed in a particular group.

At step 308, for each group, thermal control system 114 may calculate the mean and median values for the recorded temperature data for the package of processor 103. At step 310, thermal control system 114 may determine if the distribution of the recorded temperatures for processor 103 is right-skewed, which may indicate that temperature may be rising with respect to air mover speed. If the distribution of the recorded temperatures for processor 103 is right-skewed, method 300 may proceed to step 310. Otherwise, method 300 may end.

At step 312, thermal control system 114 may determine the mode value of the data points associated with air mover speed. At step 314, thermal control system 114 may create a second subset of data comprising the values of the temperature of processor 103 at such mode value of air mover speed.

At step 316, thermal control system 114 may determine if the temperature values of the second subset of data are right-skewed. If the temperature values of the second subset of data are right-skewed, method 300 may proceed to step 316. Otherwise, method 300 may end.

At step 318, thermal control system 114 may determine that the performance of air mover 108 is degraded, and perform a remedial action, as described above. At the conclusion of step 318, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented in whole or part using thermal control system 114 and/or any other system operable to implement method 300. In certain embodiments, method 300 may be implemented partially or fully in software and/or firmware embodied in computer-readable media

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
an air mover configured to drive airflow within the information handling system; and
a management controller communicatively coupled to the processor and configured to assess a cooling efficiency of the air mover by:
causing a constant computational load to be executed by the processor;
during execution of the computational load, collecting data regarding power consumption by the processor, an ambient temperature of the information handling system, a package temperature of the processor, and a speed of the air mover;
analyzing a distribution of the package temperature relative to the speed of the air mover; and
determining the air mover to be degraded in performance if the distribution is statistically right-skewed.

2. The information handling system of claim 1, wherein the management controller is configured to perform a remedial action if the air mover is determined to be degraded.

3. The information handling system of claim 1, wherein:
analyzing the distribution of the package temperature relative to the speed of the air mover comprises:
performing a first filtering of the data to filter out data samples in which power consumption by the processor does not adhere to a power parameter;
performing a second filtering of the data that separates the data into a plurality of groups, wherein the ambient temperature is the same for all data placed in a particular group;
for each group of the plurality of groups, determining if values for the package temperature in such group are statistically right-skewed;
if the package temperature in any group of the plurality of groups is statistically right-skewed, determining a mode value for the speed of the air mover for such group;
creating a second set of data comprising values of the package temperature at the mode value; and
determining if the package temperature within the second set of data is right-skewed; and
determining the air mover to be degraded in performance comprises determining that the package temperature within the second set of data is right-skewed.

4. A method for assessing a cooling efficiency of an air mover comprising:
causing a constant computational load to be executed by a processor;
during execution of the computational load, collecting data regarding power consumption by a processor, an ambient temperature of an information handling system comprising the processor and the air mover, a package temperature of the processor, and a speed of the air mover;
analyzing a distribution of the package temperature relative to the speed of the air mover; and
determining the air mover to be degraded in performance if the distribution is statistically right-skewed.

5. The method of claim 4, further comprising performing a remedial action if the air mover is determined to be degraded.

6. The method of claim 4, wherein:
analyzing the distribution of the package temperature relative to the speed of the air mover comprises:
performing a first filtering of the data to filter out data samples in which power consumption by the processor does not adhere to a power parameter;
performing a second filtering of the data that separates the data into a plurality of groups, wherein the ambient temperature is the same for all data placed in a particular group;
for each group of the plurality of groups, determining if values for the package temperature in such group are statistically right-skewed;
if the package temperature in any group of the plurality of groups is statistically right-skewed, determining a mode value for the speed of the air mover for such group;
creating a second set of data comprising values of the package temperature at the mode value; and
determining if the package temperature within the second set of data is right-skewed; and
determining the air mover to be degraded in performance comprises determining that the package temperature within the second set of data is right-skewed.

7. An article of manufacture comprising:
a non-transitory computer-readable medium; and
computer-executable instructions carried on the computer-readable medium, the instructions executable on a processing device, the instructions, when read and executed, for causing the processing device to:
cause a constant computational load to be executed by a processor;
during execution of the computational load, collect data regarding power consumption by a processor, an ambient temperature of an information handling system comprising the processor and an air mover, a package temperature of the processor, and a speed of the air mover;
analyze a distribution of the package temperature relative to the speed of the air mover; and
determine the air mover to be degraded in performance if the distribution is statistically right-skewed.

8. The article of claim 7, the instructions for further causing the processor to perform a remedial action if the air mover is determined to be degraded.

9. The article of claim 7, wherein:
analyzing the distribution of the package temperature relative to the speed of the air mover comprises:
performing a first filtering of the data to filter out data samples in which power consumption by the processor does not adhere to a power parameter;
performing a second filtering of the data that separates the data into a plurality of groups, wherein the ambient temperature is the same for all data placed in a particular group;
for each group of the plurality of groups, determining if values for the package temperature in such group are statistically right-skewed;
if the package temperature in any group of the plurality of groups is statistically right-skewed, determining a mode value for the speed of the air mover for such group;
creating a second set of data comprising values of the package temperature at the mode value; and
determining if the package temperature within the second set of data is right-skewed; and
determining the air mover to be degraded in performance comprises determining that the package temperature within the second set of data is right-skewed.
